(19) United States
(12) Patent Application Publication
(10) Pub. No.: US 2001/0044800 A1
(43) Pub. Date: Nov. 22, 2001

(54) Internet organizer

(76) Inventor: Sherwin Han, Portsmouth, RI (US)

Correspondence Address: FOLEY, HOAG & ELIOT, LLP, PATENT GROUP, ONE POST OFFICE SQUARE, BOSTON, MA, 02109, US

(21) Appl. No.: 09/789,683

(22) Filed: Feb. 21, 2001

Related U.S. Application Data
(60) Provisional application No. 60/184,000, filed on Feb. 22, 2000.

(51) Int. Cl. G06F 17/30; G06F 15/16

(52) U.S. Cl. 707/104.1; 707/10; 709/219; 706/45

(57) ABSTRACT

A system and method to organize information on the internet for rapid and organized retrieval. Registrants of websites can register URLs by specifying the URL and associated descriptors. A bot automatically determines URLs and metadata associated with the registered URL. The URLs and descriptors and/or metadata form a URL database. Search terms entered by users can be indexed against a knowledge database using one or more retrieval algorithms to provide keyword associations. The knowledge database further includes a knowledge acquisition and retrieval system and method that include at least one first memory segment, and a distinct second memory segment, wherein elements of the at least one first memory segment reciprocally associate to elements of the second memory segment. Registrants can modify the knowledge database to incorporate non-traditional associations. The search term, keyword associations, and URL associations provide an organized search result that includes subcategories and cross-categories of information that can be further searched by the user. URL links can be provided in the search results.

### CLAIM OF PRIORITY

This application claims priority to U.S. Provisional Application No. 60/184,000, entitled “Search Engine having a Two Stage Artificial Memory”, and filed on Feb. 22, 2000, naming Sherwin Han as inventor, the contents of which are herein incorporated by reference.

### BACKGROUND OF THE INVENTION

(1) Field of the Invention

The present invention relates generally to information storage and retrieval, and more particularly to methods and systems for organizing information for efficient retrieval.

(2) Description of the Prior Art

The internet's popularity continues to increase at an extremely rapid pace, with increasing numbers of business opportunities arising as a result of the network. There is a common belief that an internet presence in the form of a website is essential to continued commercial success, even though the internet presence is merely an aspect of the total business plan. As important as the internet presence may be perceived, however, some widely anticipated internet opportunities have not been realized and the result is often a dismemberment of the resources and effort originally compiled to finance and/or operate the business venture.

It is one opinion that the rapid growth of the internet caused many businesses to prioritize time in attaining an internet presence at the expense of basic human factors issues in designing their websites. As a result, many websites are difficult to navigate, and when an internet user finds a website wherein the user believes the website includes the information the user is seeking, it is often difficult for the user to find the information within the myriad of sub-pages, advertisements, and other content that can appear as part of the website. It is believed that this general lack of internet information, even at the web page level, is a reason for the failure of some internet practices. The tremendous amount of information available through the internet cannot be fully exploited or realized with the current, unorthodox, and non-uniform information organization structures that prevent existing search engines and other localized searching techniques from providing valuable search results.

It should be recognized that the heart of the internet, computers, do not store, process, or retrieve information in the same manner as the human brain. In nearly all instances, the human knowledge processing system is more efficient than existing computer processing algorithms. Research and concepts including neural networks, fuzzy logic, etc., attempt to simulate the human brain's vast capability to learn and associate in complex manners. Prior art systems disclose rule-based solutions as opposed to structure-based solutions that are constructed in the human brain.

The human brain's associative capabilities are not limited like a computer to words or pure binary data stimuli. The human brain makes associations based upon visual data, auditory data, sensory data such as touch, and motion data, all of which emanate from the physical world. The human brain therefore stores, associates, and can recall multiple data species with a single object. For example, the brain may associate “banana” with the category of fruit, the spoken word banana, the image of a ripe yellow banana, the image of a non-ripe green banana, the smell of a banana, the texture of a banana peel, etc.

There is not currently a efficient mechanism for applying human-like storage and data retrieval mechanisms to the information on the internet.

What is needed is a system and method that simulates the human brain's knowledge acquisition and retrieval mechanisms to provide increased efficiency data retrieval for large amounts of data such as found on the internet.

### SUMMARY OF THE INVENTION

The present invention provides an apparatus and method to organize, transform, and associate information between two conceptually graduated memory stages that can form the basis for a knowledge database. In an embodiment, the conceptually graduated memory stages can be utilized to make associations between a search term, and other descriptor terms that can describe data such as a document or web document. In an embodiment, the web document can be a web page that can be further associated with a Uniform Resource Location (URL) and an Internet Protocol (IP) address.

In one embodiment, a registrant can register a web page by providing a URL with a list of descriptors. The descriptors can be associated with the respective URLs using traditional database techniques to form a URL database. Alternately and optionally, a bot or robot can determine URLs related to the registered URL, and similarly identify descriptors related to the associated URLs. In an embodiment, the related descriptors can be metadata, although the invention is not limited to such acquisition of descriptor data. The associated URLs and related descriptors can be added to the URL database. The URL database can be separate from or related to the knowledge database.

In an embodiment, a search term can be presented to the methods and systems such that associated keywords are identified based on the search term by accessing the knowledge database. Similarly, a list of URLs can be identified wherein the identified URLs associate with a descriptor that matches, exactly or in partial form, the search term. Subcategories and cross-categories of search terms can be identified and presented to the user whom entered the search term to allow an organized presentation of search results. Search results can include URLs and HTTP links to URLs. Subcategories and cross-categories can be explored by users.

In an embodiment, registrants can access and add data to the knowledge database to present word associations that are otherwise not known or traditional. For example, an association between “apple” and “computer” can be entered, while the association between “apple” and “fruit” is likely already part of the knowledge database. An interface allows registrants to view the current knowledge database records to determine if an addition is necessary.

Other objects and advantages of the present invention will become more obvious hereinafter in the specification and drawings.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 diagrammatically presents the basic structural knowledge acquisition and retrieval system;

FIGS. 2A, 2B, and 2C present examples of the reciprocal association algorithm;

FIG. 3 is a sample, reciprocally associated database containing a physical data segment and a conceptual data segment;

FIGS. 4A and 4B diagrammatically present a hierarchical Is structure as viewed by the recall and categorization retrieval algorithms, respectively;

FIG. 5 displays the retrieval algorithms of the illustrated embodiments and their mathematical representations as described herein;

FIG. 6 depicts the external systems and functionality that may be imported or exported from the knowledge acquisition and retrieval system;

FIG. 7 provides a block diagram of an execution module that extracts data from the knowledge acquisition and retrieval system;

FIG. 8. illustrates an embodiment of the Internet or Web Organizer that utilizes the two stage memory of the knowledge acquisition and retrieval system of FIGS. 1 through 7;

FIG. 9 presents an illustrative graphical user interface (GUI) for the Web Organizer of FIG. 8, wherein the GUI can be implemented as a webpage;

FIG. 10 provides an exemplary portion of a URL database according to a system of FIG. 8;

FIG. 11 illustrates a system and method according to a system of FIG. 8 for augmenting the FIG. 8 knowledge database;

FIGS. 12A and 12B provide illustrative block diagrams demonstrating a URL registration and keyword association process, respectively, for a system according to FIG. 8;

FIG. 13 is an exemplary portion of a Knowledge database according to FIG. 8;

FIGS. 14A, 14B, and 14C illustrate the concepts of descriptors, subcategories, and cross-categories; and, FIG. 15 presents illustrative search results for a Web Organizer according to FIG. 8.

### DESCRIPTION OF THE ILLUSTRATED EMBODIMENT

To provide an overall understanding of the invention, certain illustrative embodiments will now be described; however, it will be understood by one of ordinary skill in the art that the systems and methods described herein can be adapted and modified to provide systems and methods for other suitable applications and that other additions and modifications can be made to the invention without departing from the scope hereof.

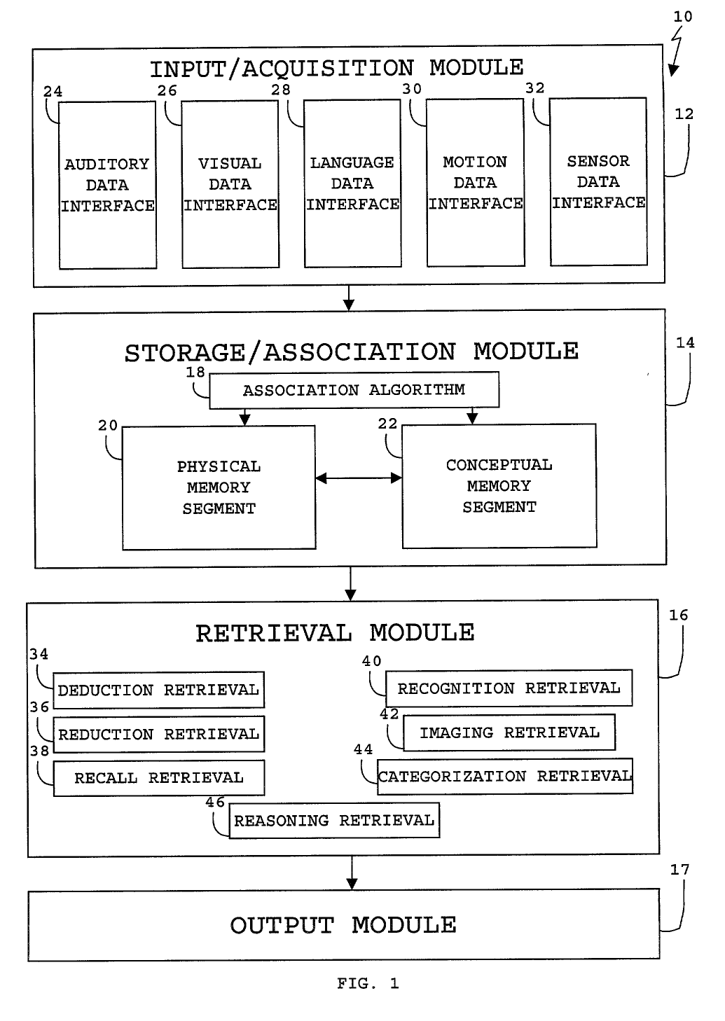

FIG. 1 represents one embodiment of the knowledge acquisition and retrieval system 10 that incorporates the principles of the invention. Such a system can be implemented using a digital computer system and information sources that are accessible via a communication network, keyboard, digital camera, microphone, etc. The digital computer system can be any microprocessor-based system including a computer workstation, such as a PC workstation or a SUN workstation, that comprises a program for organizing and controlling the digital computer system to operate as the system according to the invention. Additionally and optionally, the microprocessor-based system can be equipped for processing multimedia data, and can be, for example, a conventional PC computer system with a sound and video card. The computer system can operate as a stand-alone system or as part of a networked computer system. Alternatively, the computer systems can be dedicated devices, such as embedded systems, that can be incorporated into existing hardware devices, such as telephone systems, PBX systems, sound cards, etc. Accordingly, it will be understood by one of ordinary skill in the art that the systems and methods described herein have wide applicability and can be incorporated in many systems, and realized in many forms, all without departing from the scope of the invention.

Referring to FIG. 1, the illustrated knowledge acquisition and retrieval system 10 can be described by referring to four basic structural components that are presented merely for explanatory purposes, and are not intended to represent a limitation of the invention herein: An input/acquisition module 12, a storage/association module 14, a retrieval module 16, and an output module 17. Because in the illustrated system, input/acquisition module 12 and retrieval module 16 components are based on the storage/association module 14 components, the storage/association module 14 shall be described first.

The FIG. 1 storage/association module 14 includes an association algorithm 18 and two memory segments designated in FIG. 1 as a physical memory segment 20, and a conceptual memory segment 22. The association algorithm interfaces between the input/acquisition module 12 and the two memory segments 20, 22 to ensure that outputs of the input/acquisition module 12 resolve into reciprocally associated physical and conceptual memory elements.

The storage/association module's 14 two memory segments 20, 22 emulate the human brain storage mechanism. The human brain can be understood to include two memories that shall be referred to herein as representational memory and consciousness memory. Representational information can be understood as information received directly by the senses from the physical world. Alternately, consciousness information can be understood as information not directly received from the senses, but rather generated from representational information and may be viewed as a property of representational information or a shared group of representational information. Consciousness data can be viewed as abstract data, and can be retained at a higher level of categorization than the representational data received from the physical world. For simplicity, the remainder of this specification shall refer to representational data as physical data, and consciousness data as conceptual data. Correspondingly, the FIG. 1 illustration indicates the physical memory segment 20 for storing physical data, and the conceptual memory segment 22 for storing conceptual data.

The illustrated association algorithm 18 reciprocally associates physical memory elements to at least one conceptual memory element. Because the illustrated physical and conceptual memory segments 20, 22 are reciprocally associated, they may be constructed from a single memory that is divided into two segments, or two physically separate memory segments. Similarly the reciprocal associations can be established through any linking device including pointers and/or linked lists, but the invention is not so limited. In an embodiment, the memory is constructed upon a database system, such as Microsoft Access, ODBC, or SQL Server. Those with ordinary skill in the art will recognize that the physical and conceptual memory segments can be memories that may be otherwise partitioned physically or logically, without departing from the scope of the invention.

In an embodiment, the input/acquisition module 12 can be a multi-modality input system that simulates the human senses. Referring to FIG. 1, the input/acquisition module 12 includes interfaces to accept auditory data 24 including sounds input by a microphone, visual data 26 including graphs and images, language data 28 including written, spoken, scanned, and FAXed text, motion data 30 including positional information from sonar, radar, etc., and sensor data 32 that can be from any electronic measuring device including sonar, radar, temperature sensors, medical devices, etc., although such examples are provided for illustration and not limitation.

Each of the illustrated multi-modal input interfaces 24, 26, 28, 30, 32 provide a mechanism to allow the user to identify that data comprising the physical data, and that data comprising the conceptual data. For example, auditory information can be input through a microphone to record a baby crying. In this example, the sound is the physical data, while “baby crying” is the abstract or conceptual data. A picture of Abraham Lincoln can be scanned through the visual data interface as physical data, with “Abraham Lincoln” associated as the conceptual data. Language data can be input through any interface, for example a graphical user interface (GUI) that prompts for physical and conceptual data pairs, e.g., “George Washington”-“president” can be entered as the physical-conceptual pair. Positional data received from radar is representative of physical data from the motion data interface 30, while the corresponding conceptual data would be “current position”. Similarly, a temperature reading from a thermometer can be introduced through the sensor data interface 32 as physical data, with the associated conceptual data being “temperature”.

The illustrated association algorithm 18 within the storage/association module 14 can accept the physical-conceptual data pairings from the multi-modal input/acquisition module 12, transfer the data to the respective physical and conceptual memory segments, 20, 22, and form reciprocal associations between the newly entered data elements. A further function of the FIG. 1 association algorithm 18 is to identify physical data as auditory, visual, language, motion, or sensory.

In an embodiment, to further emulate the human brain, the illustrated physical data memory segment 20 can be further divided into multiple partitions, with partitions corresponding to a respective input mode or data type. As shown by FIG. 1, because there are five different modal inputs (e.g., auditory, visual, language, motion, and sensor), the illustrated physical memory segment 20 maintains five partitions, thereby organizing the information received by each modal input. Alternately, the illustrated system conceptual memory 22 is not partitioned.

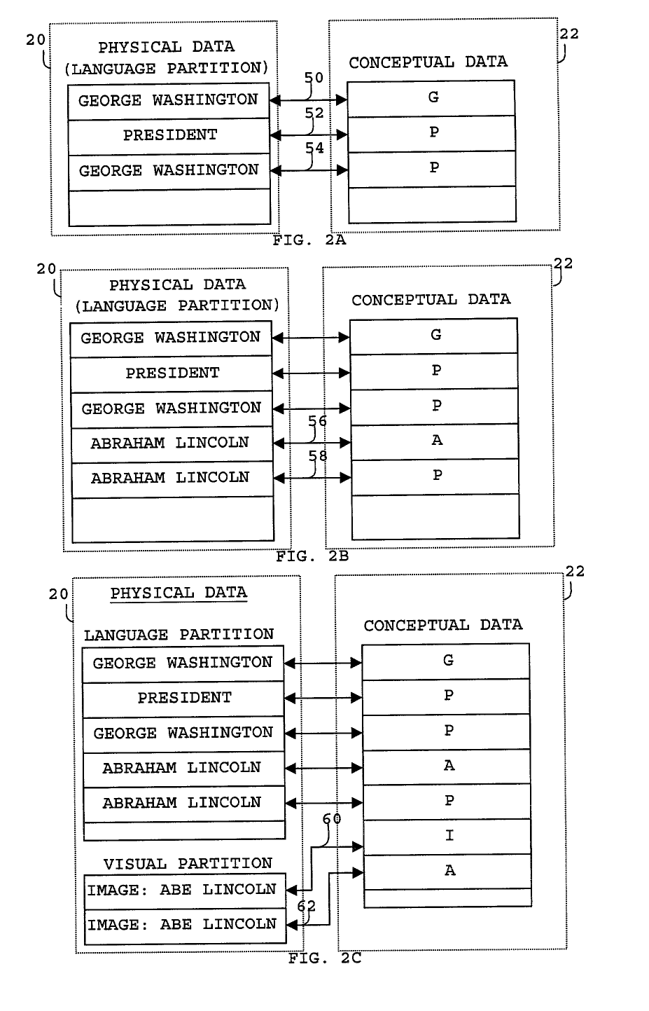

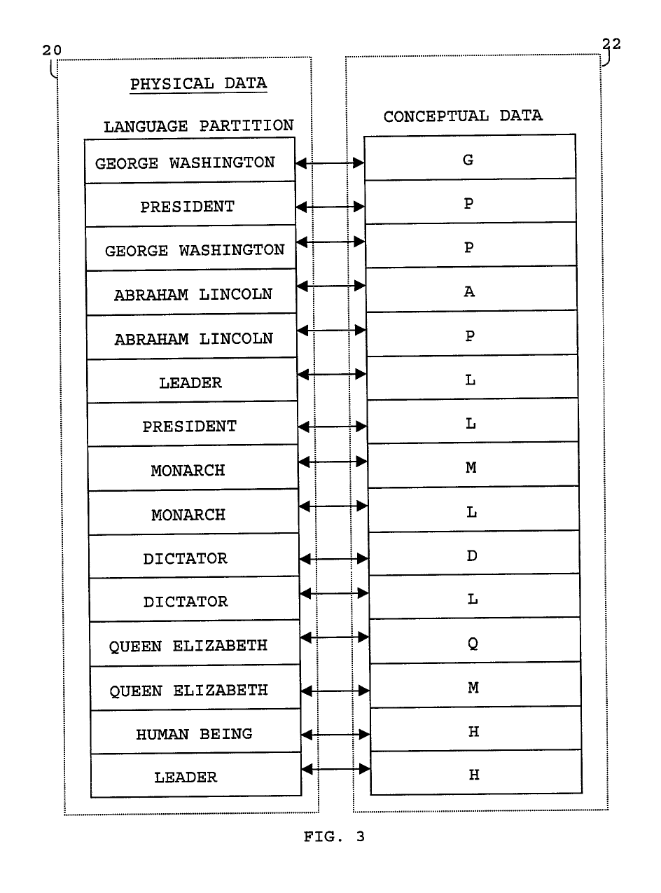

Referring now to FIG. 2A, there is shown an example of the physical and conceptual memory segments after language data is input through the language data interface. In one embodiment, the language data interface comprises a GUI that prompts a user for physical data and its associated conceptual data. In the example provided by FIG. 2A, “George Washington-President” is entered as the physical-conceptual data pair. From this data pair, the illustrated system “learns” the relationship between the physical and conceptual elements by associating the physical and conceptual data elements as shown by FIG. 2A. For simplicity, FIG. 2A represents only the language partition of the physical data memory 20.

Upon receiving the data pair “George Washington-President”, the FIG. 1 association algorithm 18 can establish three reciprocal associations between the physical and conceptual memory segments. In this instance, the language partition of the physical data segment is utilized because the data is from the language data interface. The first association can be established using the rule that every physical data element can be reciprocally associated to a conceptual data element. In FIG. 2A, “George Washington” is reciprocally associated 50 to the abstract concept “G”. The second reciprocal association can be established by the rule that every conceptual data element can be reciprocally associated to a physical data element. In FIG. 2A, this reciprocal association can be demonstrated by “president” (physical data) reciprocally associating 52 to the abstract concept “P”. The third reciprocal association can established by the data pairing itself, and shown in FIG. 2A as 54. The physical (language partition) data of “George Washington” is reciprocally associated 54 to the abstract concept of “P”, wherein P is shown by 52 to be the abstract concept relating to the physical data of president. In the illustrated system, the three reciprocal connections 50, 52, 54 complete the learning process for the example input.

Continuing the example, consider that additional language information is input similarly as “Abraham Lincoln-President”. Referring now to FIG. 2B, there is shown the physical and conceptual memory segments 20, 22 with pre-existing reciprocal associations from FIG. 2A, and new reciprocal associations indicated. The FIG. 1 association algorithm 18 first establishes a reciprocal association 56 between “Abraham Lincoln” in the physical memory segment (language partition) and an abstract concept A in conceptual memory 20. Secondly, the illustrated association algorithm 18 seeks to establish an association between the conceptual element P and president; however, this relationship has already been learned, and therefore it is not necessary to “learn” this concept again by entering the relationship. Thirdly, a reciprocal association is established between the physical data of “Abraham Lincoln” and the conceptual data P 58, wherein P is the conceptual element relating to the physical data known as “President”.

As a third step in the input/acquisition process, consider a visual input comprising an image of Abraham Lincoln. The physical data is the image, while the conceptual data is “Abraham Lincoln.” Referring now to FIG. 2C, there is shown pre-existing reciprocal associations from FIG. 2B, with additional reciprocal associations established. The association algorithm 18 can place the image in the visual data partition of physical memory 20, and establish the reciprocal associations. First, a reciprocal association 60 can be established between the physical data image and a conceptual data element. Secondly, a reciprocal association between the concept “Abraham Lincoln” and a physical data element is sought, and determined to be already established, or learned. Thirdly, the physical data image is reciprocally associated to the abstract concept representing Abraham Lincoln 62.

Although the example provided was limited to language and visual data, as already noted, the invention is not so limited, additionally allowing auditory, motion, and sensor data, with similar partitions of the physical memory segment. Similarly, although the invention is capable of auditory, motion, visual, sensor, and language inputs, it is not necessary to include all input modes to embody the invention. The number of associations created is only limited by the memory segment size (if physical data is partitioned into segments, partition sizes must also be considered.) Referring back to FIG. 1, for discussion purposes, the third major component of the illustrated knowledge acquisition and retrieval system 10 is the retrieval module 16. The illustrated retrieval module 16 is primarily responsible for emulating the human brain's cognitive capabilities by retrieving data from physical memory and outputting the data to a desired format or medium for the multi-modal output module 17. Because the physical data can be divided into auditory, visual, language, motion, and sensor partitions, with each partition representative of the data stored therein, the potential system outputs can correspondingly be auditory, visual, language, motion, and sensor data. Auditory data can be output to a speaker, visual and language data may be output to document, screen, GUI, or other computer readable medium, and motion and sensor data can be output to another device, instrument, GUI, document, etc. The output module 17, similar to the input/acquisition module 12, can also be multi-modal, and comprises interfaces to the various output devices.

The retrieval module 16 comprises a set of algorithms that traverse reciprocal associations between the physical memory segment 20 and the conceptual memory segment 22 according to a designated retrieval method. Because the illustrated knowledge acquisition and retrieval system 10 emulates the human brain, all outputs are extracted from physical memory 20, whose elements represent the physical world. In the retrieval process, the illustrated conceptual memory 22 is accessed merely to derive associations to physical memory elements.

In an embodiment, the retrieval module 16 comprises seven retrieval algorithms that are selectable through a GUI. Depending upon the selected retrieval algorithm, the GUI can prompt the user for inputs. The seven retrieval algorithms can simulate human brain retrieval processes, and may be defined as deduction 34, reduction 36, recall 38, recognition 40, imaging 42, categorization 44, and reasoning 46.

Deduction 34 is a retrieval algorithm to extract exclusively from the language partition of physical data memory. Deduction can be defined as the set of conceptual data related to a physical data element, wherein the physical data element is categorized as language data, and the related conceptual data is associated to language data. Referring now to FIG. 3, there is a database representing the language partition of physical data memory 20, and conceptual data memory 22, with established reciprocal associations as indicated. A deduction retrieval request for the user-specified physical data element “George Washington” presents the set of conceptual data associated to “George Washington”. Using the example database of FIG. 3, a search through physical data memory for all conceptual data associated to “George Washington” provides conceptual data “G” and “P”. Once again, the retrieval algorithm cannot generate abstract ideas, but must generate the corresponding physical world equivalents. Since “G” reciprocates to “George Washington”, or the input data, it is not provided as an output; however, “P” reciprocates to “President”, which comprises physical world data different from the input. The deductive output for “George Washington” is therefore “President”. This process is considered a linear retrieval from conceptual data (consciousness data), wherein the input is physical, language data, and the output is also language data associated with the retrieved conceptual data. Because there is only one input yet potential multiple outputs, this process is hereby defined as a single-input process. This retrieval may be mathematically expressed as L<C, where L signifies the input Language data, <indicates a single input producing potentially multiple outputs, and C signifies the retrieved conceptual data.

Recognition retrieval 40 is the same retrieval algorithm as deduction, except whereas deduction is limited to a single, language physical data input, recognition retrieval 40 accepts as input a single, physical data input from any physical data category other than the language type (i.e., auditory, visual, motion, or sensor), and outputs the conceptual data related to the input. Depending upon the input category, this retrieval may be mathematically expressed as A<C, V<C, M<C, S<C, where A signifies auditory data input, V signifies visual data input, M signifies motion data input, and S signifies sensor data input. Once again, as in deduction, there can be multiple outputs for recognition.

Reduction retrieval 36, like deduction retrieval 34, can be limited to retrieving physical data from the language partition. Reduction retrieval generates the set of (language) physical data that is related to a specified conceptual idea (input). Referring again to the sample database of FIG. 3, if “Leader” is presented as the conceptual element, “Leader” is conceptually represented as “L”. A search through conceptual memory for physical data associated to “L” (other than the input, “Leader”) provides “President”, “Monarch”, and “Dictator”, which include the output of a reduction inquiry with “Leader” as the input. In reduction, for the illustrated systems, there is exactly one input, yet potential multiple outputs. Mathematically, this may be represented as C<L, where C signifies the single conceptual data input, <signifies a single input and potential multiple outputs, and L signifies the Language data output(s).

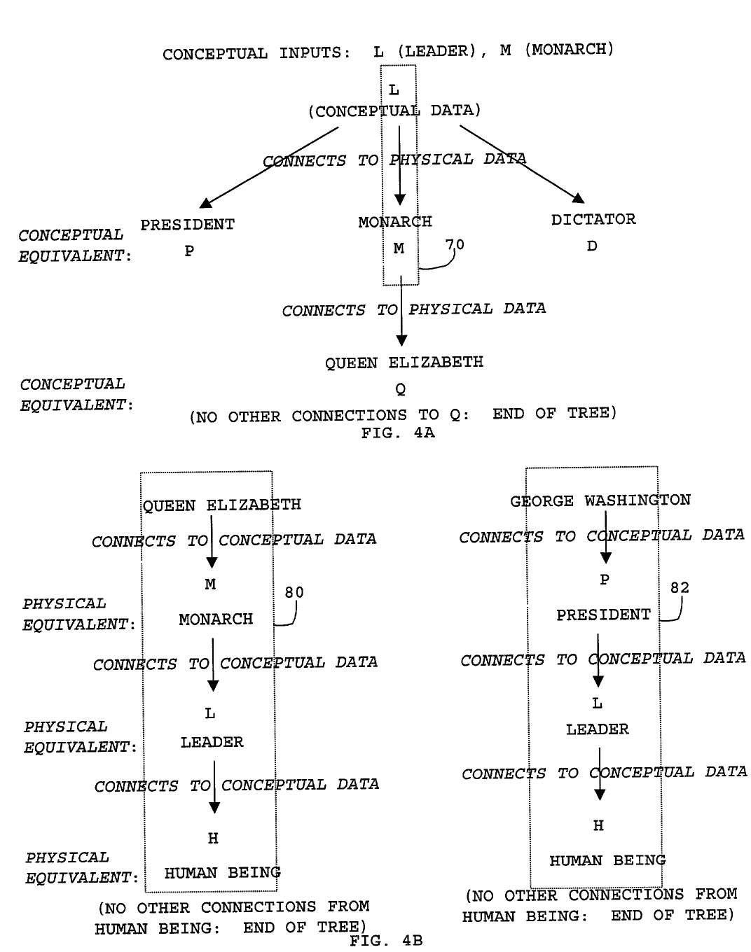

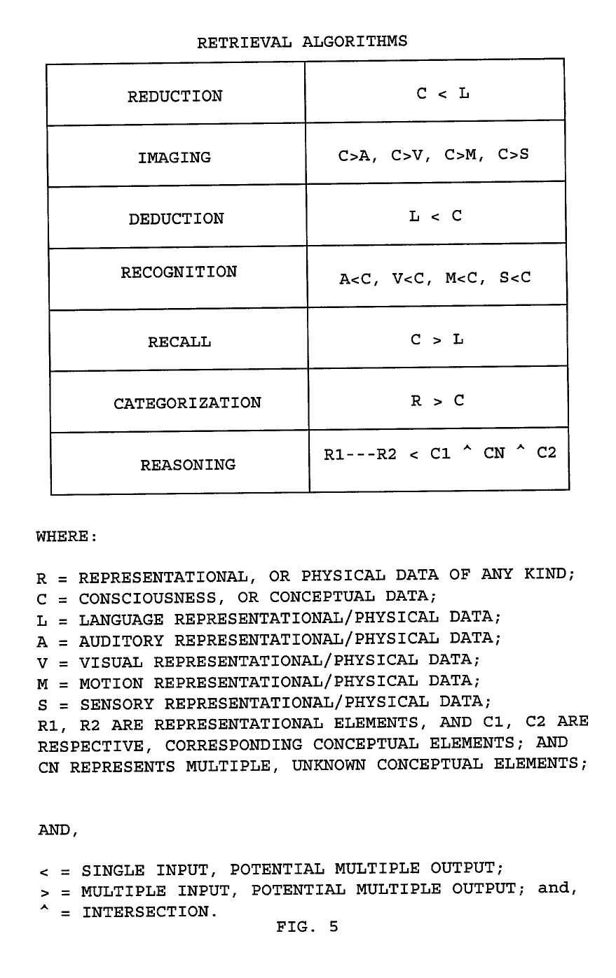

Recall retrieval 38 can be an algorithm performing the same procedure as reduction, except recall requires two or more conceptual data inputs. Recall can provide as output those physical data elements identified as language data, that represent the physical data common to the two or more conceptual data inputs. Referring to the sample database of FIG. 3, consider two inputs of “Leader” and “Monarch” as the conceptual elements, corresponding to “L” and “M” respectively. Referring now to FIG. 4A, there is shown the tree diagram representing the recall retrieval algorithm. A search through conceptual data for “L” provides reciprocal associations with “President”, “Monarch”, and “Dictator”, otherwise conceptually represented as “P”, “M”, and “D”, respectively. Because the connection containing “L” and “M” is the desired connection and it is already established, it is now only necessary to pursue the reciprocal associations of the common branch 70. A search through the FIG. 3 database conceptual data for the conceptual data “M” provides a single reciprocal association to “Queen Elizabeth”. A similar search in conceptual data for “Q”, the conceptual equivalent of “Queen Elizabeth”, does not provide any reciprocal associations, thereby ending the recall retrieval algorithm. The single recall algorithm output for this example is therefore “Queen Elizabeth”; however, if multiple monarchs were listed, the recall retrieval would have produced multiple outputs. This recall function operates in the same manner as the human brain to recall information having specified common properties. Mathematically, recall retrieval may be expressed as C>L, where C signifies conceptual data, >indicates multiple inputs with potential multiple outputs, and L signifies language, physical data. An alternate mathematical representation for recall with two inputs may be C1+C2>L1ˆ L2, where C1 is the first conceptual input, C2 is the second conceptual input, L1 is the language physical data associated with C1, L2 is the language physical data associated with C2, and ˆ denotes intersection.

Imaging retrieval 42 is the same retrieval process as recall retrieval 36, however whereas recall 36 can be limited to retrieving from the language partition of the physical memory segment, imaging 42 can be limited to retrieving from the auditory, visual, motion, and sensor partitions of physical memory 20. Imaging can be mathematically represented as C>A, C>V, C>M, and C>S, where C signifies the multiple conceptual data inputs, >represents multiple inputs, and A signifies potential multiple auditory outputs, V signifies potential multiple visual outputs, M signifies potential multiple motion outputs, and S signifies potential multiple sensor outputs. Alternately, imaging for two inputs can be represented as C1+C2>R1ˆ R2, where C1 and C2 are the conceptual inputs, R1 and R2 are the respective, non-language representational (physical) data, and ˆ denotes intersection.

Categorization retrieval 44 can require two or more inputs representing physical data inputs. Categorization retrieval produces those conceptual data elements that the two physical data inputs share. As an example using the database from FIG. 3, consider inputs of “Queen Elizabeth” and “George Washington”. Conceptually, categorization produces a tree for each physical data input, and produces as output the common elements, or intersection, of the respective trees. FIG. 4B illustrates the trees produced for the respective physical data inputs. Using the FIG. 3 sample database, a search for “Queen Elizabeth” in physical data presents reciprocal associations to M conceptually. M is physically represented as Monarch, and a search for “Monarch” in physical data produces reciprocal associations to conceptual data L. Continuing, a search of physical data for “Leader” (corresponding to L) provides reciprocal associations with H, or “Human Being”. A search of “Human Being” in physical data does not reciprocally associate with any other concept, thereby ending the tree 80. A similarly constructed tree can be produced by performing the same analysis using the FIG. 3 sample database, but beginning with “George Washington” 82, and repeatedly searching the physical data memory for reciprocal associations. The categorization output is the intersection of the trees for “Queen Elizabeth” 80 and “George Washington” 82, thereby producing an output of “Leader” and “Human Being”. Much like the human mind, categorization retrieval generates the common elements, i.e., Queen Elizabeth and George Washington both were leaders and human beings. Mathematically, categorization may be represented as R>C, where R signifies representational data (i.e., any physical data), >represents multiple inputs and potential multiple outputs, and C signifies the potential, multiple conceptual data outputs. An alternate mathematical representation for two inputs is R1+R2>C1ˆ C2, where R1 and R2 are the physical (representational) data inputs, C1 and C2 are the corresponding conceptual data, and ˆ denotes intersection.

Referring back to FIG. 1, reasoning retrieval 46 can accept two or more elements from physical data as input, and generate an output equivalent to those conceptual data elements that connect the reasoning inputs through deduction. For example, referring to the sample FIG. 3 database, consider as input “George Washington” and “Leader”. “George Washington” connects conceptually to “P”, or “President”, and “President” connects to “L”, or “Leader”. The reasoning retrieval output for the present example is therefore “President” as the conceptual (“P”) connection between the two terms. Again, the human mind, when presented with “George Washington” and “Leader”, would reason that George Washington was a leader because he was a President. Mathematically, reasoning may be represented as R1 - - - R2<C1ˆ Cnˆ C2, where R1 and R2 are the physical (representational) data input pair, C1 and C2 are the respective conceptual data elements, Cn represents all conceptual data elements connecting C1 and C2, and A denotes intersection.

Referring now to FIG. 5, there is shown a summary of the seven retrieval algorithms with their corresponding mathematical representations as provided herein.

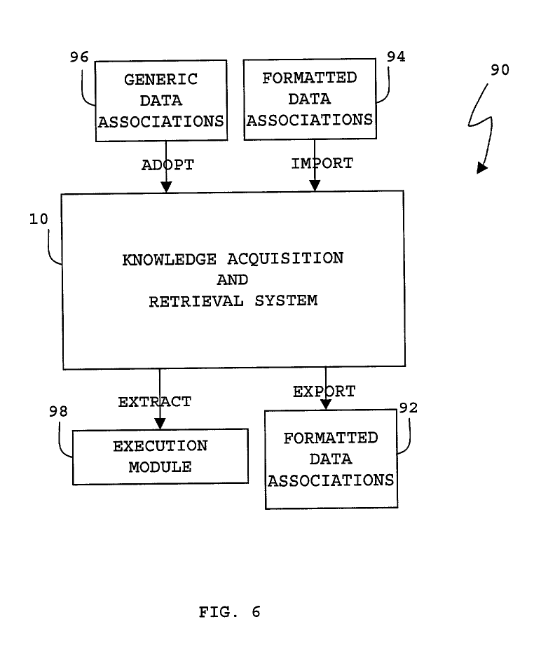

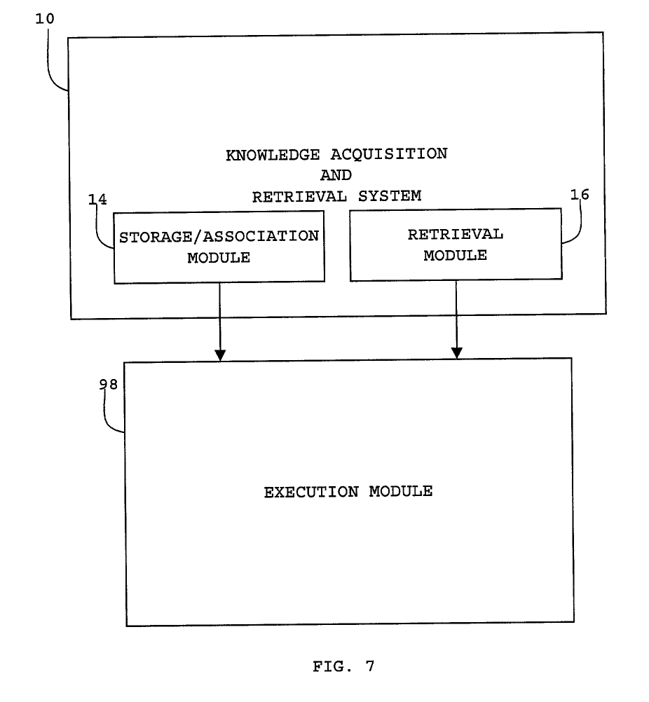

Referring now to FIG. 6, there is shown the knowledge acquisition and retrieval system 10 to illustrate additional capabilities regarding interaction with other systems. Although the present invention provides multi-modality input and output systems for auditory, language, visual, motion, and sensor data, the system 10 also allows mechanisms for data export, data import, and data adoption.

In the illustrated systems, data export is a function whereby the physical and conceptual memories, and the reciprocal associations established therein, are written in a formatted manner to an external device 92. Such external device may be a data file, other computer system connected through a network, or any computer readable medium. These formatted data associations 92 can then be imported by another system practicing the invention presented herein. The import of the formatted database 94 does not require any conversion as the formatted database comprises the required reciprocal associations. Data import from a formatted database can be a direct operation from the external database, to the physical and conceptual memory segments.

Alternately, generic databases 96 can provide data for input to the reciprocally associated physical and conceptual memories; however, because traditional databases do not provide the reciprocal associations required by the invention herein, the generic data must be reformatted to provide reciprocal association for entry into the physical and conceptual memory segments. This process can be described herein as adoption. In one embodiment, the knowledge acquisition and retrieval system 10 provides a GUI that allows selection of specific, generic databases that may be adapted to the reciprocal memory. Examples of such specific databases that can be adopted include SQL, ODBC, dBase, and Oracle, but the invention herein is not so limited, and the adoption algorithm may be adapted to include any generic database. Each generic database for adoption may require a different conversion algorithm.

In one embodiment, the knowledge acquisition and retrieval system GUI provides an interface to allow selection of data export, data import, and data adoption.

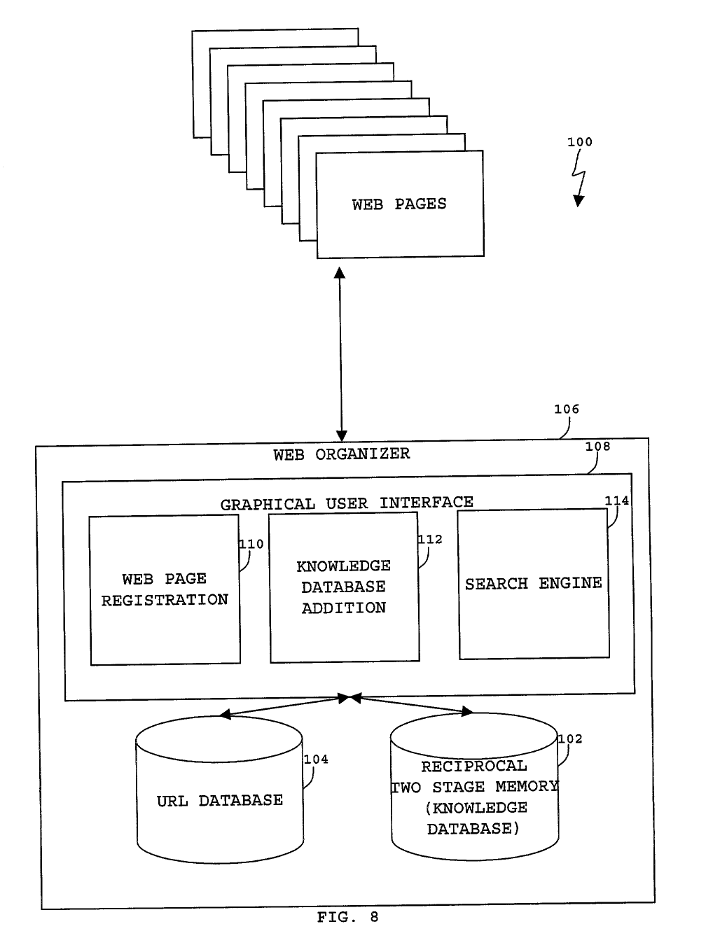

Referring again to FIG. 6, there is shown the execution module 98 that can receive or extract data from the knowledge acquisition and retrieval system 10. Referring now to FIG. 7, the illustrated execution module 10 extracts physical and conceptual data information with corresponding reciprocal associations, to form new memory associations. The execution module 98 typically extracts only a data subset from the knowledge acquisition and retrieval system 10 for the specific purpose of deriving relationships corresponding to executable functions such as walking, jumping, throwing, catching, etc. The execution module 98 can extract information directly from the storage/association module 14 (i.e., physical and conceptual memory directly), or the execution module 98 can extract data indirectly through the retrieval module 16 and its retrieval algorithms. The illustrated execution module 98 therefore includes an interface to extract data subsets from the physical and conceptual memory segments, a dual memory configuration to store the extracted data and maintain the reciprocal associations, an association or learning algorithm to further associate the extracted concepts and relate them to an activity, and an output interface to output the activity data to the desired output device or sensor.

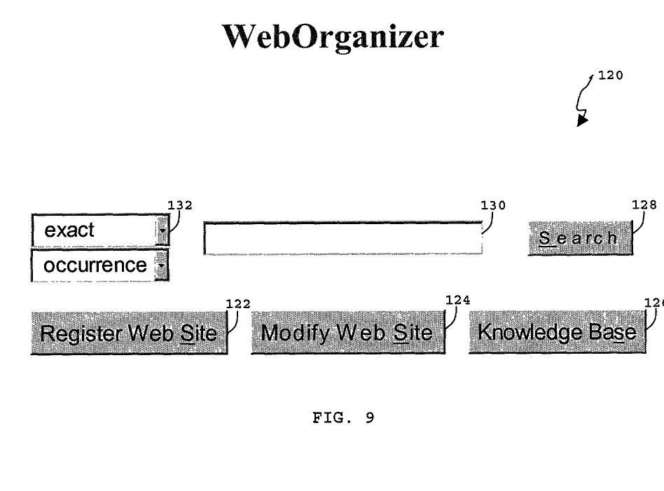

Referring now to FIG. 8, there is an illustrative diagram 100 of a system utilizing a reciprocal two stage memory 102 as described herein and in which another example is illustrated in FIG. 3. In the FIG. 8 representative system, the reciprocal memory can otherwise be referred to as a Knowledge Database 102.

The FIG. 8 system also includes a URL database 104 that associates URLs to keywords. The URL database 104 and Knowledge Database 102 can be any memory device that can have a single memory segment or partition (logical or physical), multiple memory segments having single or multiple memory partitions (logical or physical), and/or can be implemented using any one of well-known database programs including SQL, MySQL, Oracle, etc. Those with ordinary skill in the art will recognize that although the Knowledge Database 102 and URL Database 104 are illustrated as separate databases, the databases 102, 104 can be combined or otherwise divided without departing from the scope of the invention. For the purposes of the disclosure herein, references to website(s) and webpage(s) shall be understood to be a reference to a URL(s).

The FIG. 8 Knowledge and URL Databases 102, 104 can be implemented as part of a Web Organizer 106 that can organize information on a network such as the internet. The illustrated Web Organizer 106 includes a Graphical User Interface (GUI) 108 that further can be described as having functionality that includes a Web Page Registration module 110, a Knowledge Database Addition module 112, and a Search Engine module 114. Those with ordinary skill in the art will recognize that the representative system of FIG. 8 is merely illustrative and intended for explanatory purposes, and the components displayed therein may be combined or otherwise divided without departing from the scope of the invention.

For the purposes of discussion with respect to systems and methods according to FIG. 8, it can be understood that the internet is a network of computers that can be divided generically into clients and servers, where any one of well-known internet browsers executing on a client, can execute a command to retrieve requested information, including for example, a web document, web page, content information, etc., from a specified internet address that corresponds to server. A server can be understood to include a processor, a memory (e.g. RAM), a bus to couple the processor and the memory, a mass storage device (e.g. a magnetic or optical disk) coupled to the processor and the memory through an I/O controller, and a network interface coupled to the processor and the memory. The servers may further include one or more mass storage devices such as a disk farm or a redundant array of independent disks (“RAID”) system for additional storage and data integrity. Read-only devices, such as compact disk drives and digital versatile disk drives, may also be connected to the servers. Servers can be understood to be, for example, personal computers (PCs), SUN workstations, handheld, palm, laptop, cellular telephones, or other microprocessor controlled devices for performing the operations and functions as described herein and attributed to servers. Servers can be connected via networks for more efficient processing of client traffic. Servers in stand-alone or network configurations can operate together or independently for different functions, wherein a server can be designated a database server, an application server, a web server, etc. As used herein, the term “server” is intended to refer to any of the above-described servers that further includes instructions for causing the server processor to perform the functions designated and attributed to the servers herein. For the purposes of the discussion herein, the client as discusses previously, can also be a server.

As is well-known in the art, information requested of the server can be displayed or otherwise presented to a user of the client via a viewing device such as a display, screen, etc., that is otherwise integrated with the client. In an internet embodiment, user requests for information can be executed via the browser on the client wherein the browser provides an interface for the user to designate a Uniform Resource Location (URL) and cause the browser to execute an Hyper-Text Transfer Protocol (HTTP) request to the server, wherein in the illustrated embodiment, the server corresponds to the URL designated by the user. The server responds to the http request by transmitting the requested information to the client. Those with ordinary skill in the art will recognize that the retrieved information can be in the form of an HTTP object that includes plain text (ASCII) conforming to the HyperText Markup Language (“HTML”), Dynamic HyperText Markup Language (“DHTML”), Extensible Markup Language (“XML”), the Extensible Hypertext Markup Language (“XHML”), Standard Generalized Markup Language (“SGML”), etc. Additionally, the retrieved information can include hyperlinks to other Web documents, and the server can execute programs associated with the retrieved information using programming languages such as Perl, C, C++, or Java. The server can also utilize scripting languages such as ColdFusion from Allaire, Inc., or PHP, to perform “back-end” functions such as order processing, database management, and content searching. Retrieved information in the form of a web document may also include references to small client-side applications, or applets, that are transferred from the server to the client with the web document and executed locally by the client, wherein Java is one popular exemplary applet programming language. The text within a web document may further include non-displayed scripts that are executed by an appropriately enabled browser using a scripting language such as JavaScript or Visual Basic Script. Browsers can further be enhanced with a variety of helper applications to interpret various media including still image formats such as JPEG and GIF, document formats such as PS and PDF, motion picture formats such as AVI and MPEG, and sound formats such as MP3 and MIDI. These media formats, with an increasing variety of proprietary media formats, can enrich a user's interactive and audio-visual experience as a web document is presented through the browser at the client.

Those with ordinary skill in the art will recognize that application logic executed by a first server can issue a HTTP request to a second server, wherein the application logic can be executed on the second server to produce, for example, XML results. In this example embodiment, the XML results from the second server can be transferred to the first server and thereafter to the initial requesting entity (i.e. client). In other embodiments, multiple numbers of servers can make requests of each other, wherein the subsequent server's results can be transferred to a requesting server. In different embodiments, the requesting and executing servers can be configured the same or differently.

In the system of FIG. 8, the GUI 114 can be implemented as a web page using XML, HTTP, and CGI and Perl scripts, etc., as described herein, wherein such GUI or web page can be viewed using an internet browser. For example, an internet browser can present a web page to an internet user as illustrated by FIG. 9, wherein a user accessing the GUI web page 120 can be presented with options to Register a Web Site 122, Modify a Web Site 124, Access the Knowledge Database for content information or additions 126, or perform a Search 128. Referring to FIGS. 8 and 9, the Web Page Registration module 110 can be implemented through the Register Web Site 122 and Modify Web Site 124 options, while the knowledge database module 112 can be accessed and implemented through the Knowledge Base option 126. Similarly, the Search Engine 114 can be implemented through the use of a Search option 128 that utilizes a keyword textbox input 130 and a selectable option 132 to search by exact matches of the word in the keyword inputs, or occurrences of the keyword inputs. In the illustrated systems, one or more keywords can be entered by a user into the keyword input 130 and connected using relational operators such as “+” to denote logical AND, “−” to denote logical OR, etc. Other logical operands can be used without departing from the scope of the invention, for example, using characters such as AND, OR, etc. Those with ordinary skill in the art will recognize that the invention herein is not limited to the input objects such as textbox objects, selectable buttons, etc., and other processes for entering and/or receiving information can be used without departing from the scope of the invention.

The illustrated system allows a user to Register a Web site by providing, for example, a website name identifier, a URL that represents the website, a geographic location, a description of the website, and a password to protect the website-related data that is entered into the Web Organizer 106. A website registrant can also provide descriptor terms that can further describe or identify the website. For example, a law firm website registering with the Web Organizer 106 may provide descriptors related to areas of practice, such as “Taxation”, “Patents”, “Criminal”, etc. Other websites may includes descriptors relating to the services or products offered by the website.

In the illustrated embodiments, after a website is registered, the descriptor information from the registration process is transferred to the URL database 104. Additionally, a bot, or robot, as commonly known in the art, is executed to retrieve the web pages or URLs associated with and/or related to the registered website/URL, wherein in the illustrated systems, the bot further retrieves, for each related and/or associated URL or page, metadata associated with the pages. The URLs (or page) address and associated metadata can also be incorporated into the URL Database 104. Those with ordinary skill in the art will recognize that the retrieval of metadata as descriptors by bots is merely illustrative, and other mechanisms for retrieving descriptor information can be implemented without departing from the scope of the invention.

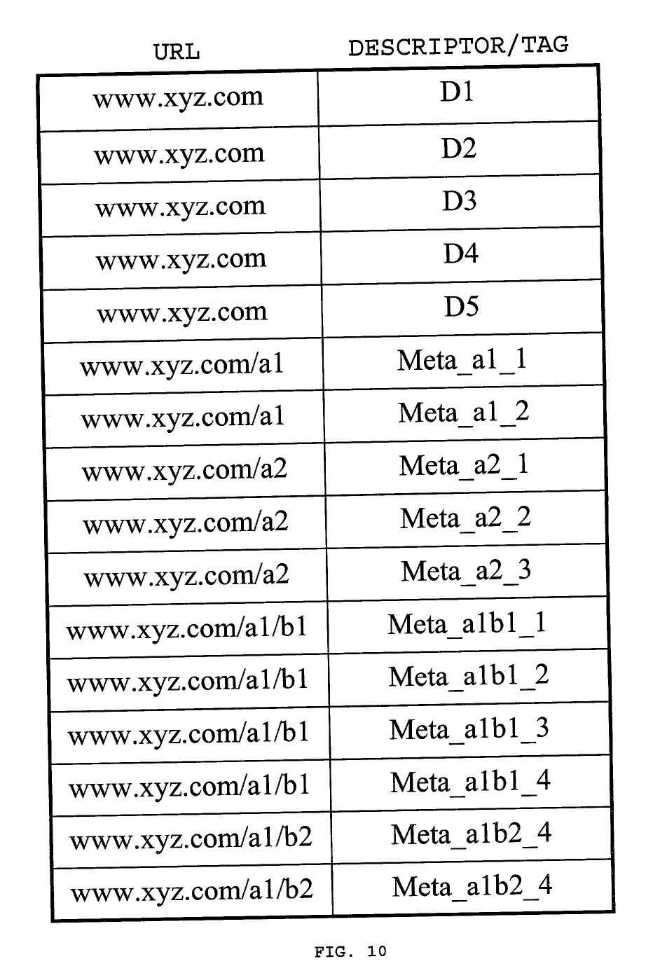

For example, FIG. 10 illustrates the result of a registration of website www.xyz.com. The FIG. 10 memory segment is merely illustrative and not intended for limitation, and includes a sample registration of www.xyz.com wherein five descriptors, D1-D5, were provided by the registrant. The bot process thereafter provided related web pages designated by www.xyz.com/?/? as those with ordinary skill in the art would recognize as the format for related URLs or web pages that are associated with the same Internet Protocol (IP) address as the registered webpage, wherein the associated metadata for the related URLs were also retrieved and placed into the URL Database 104.

Alternately and or additionally, a website registrant can decide at any time to add or delete descriptors for a registered web page by selecting the Modify Web Site option 124 such as that illustrated in FIG. 9. Additionally and optionally, a website registrant can also decide at any time after website registration, to provide additional input to the Knowledge Database 102. For example, if a registrant understands that there is an atypical use of a word in or on its website that is different, the registrant can decide to provide the Knowledge Database 102 with new entries.

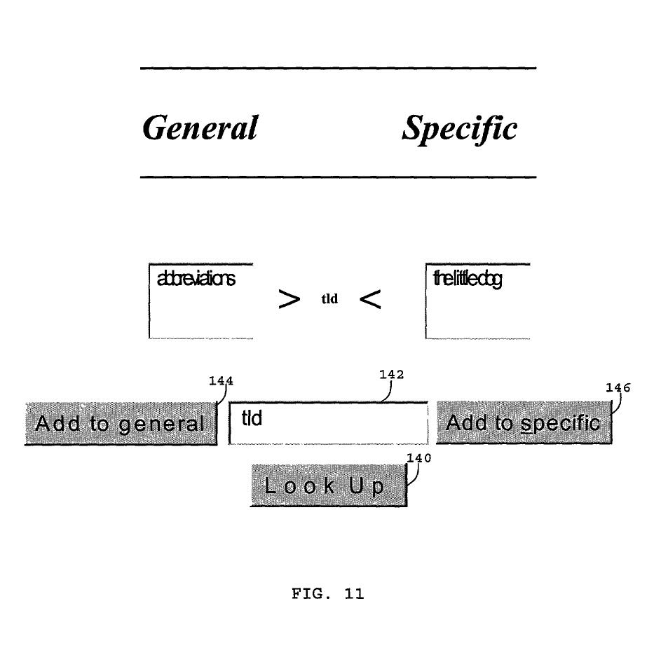

Referring now to FIG. 11, there is shown an illustration of a webpage that can be presented to a user that selects the Knowledge Database option 126. According to the illustration of FIG. 11, the two stage reciprocal memory can be represented by General (i.e., Physical) and Specific (i.e., Conceptual) data. A registrant can utilize a Look-up option 140 to determine the current representation of a word in Knowledge Database 102. For example, although the word “apple” can be associated with a fruit, the word “apple” can also be associated with a computer manufacturer. Should a meaning of the word not be currently represented as intended or desired by a registrant, the registrant can utilize a textbox or keyword box 142 to enter a word, and thereafter utilize the Add to General 144 or Add to Specific 146 options accordingly to enter, or register, a new definition or association for the word.

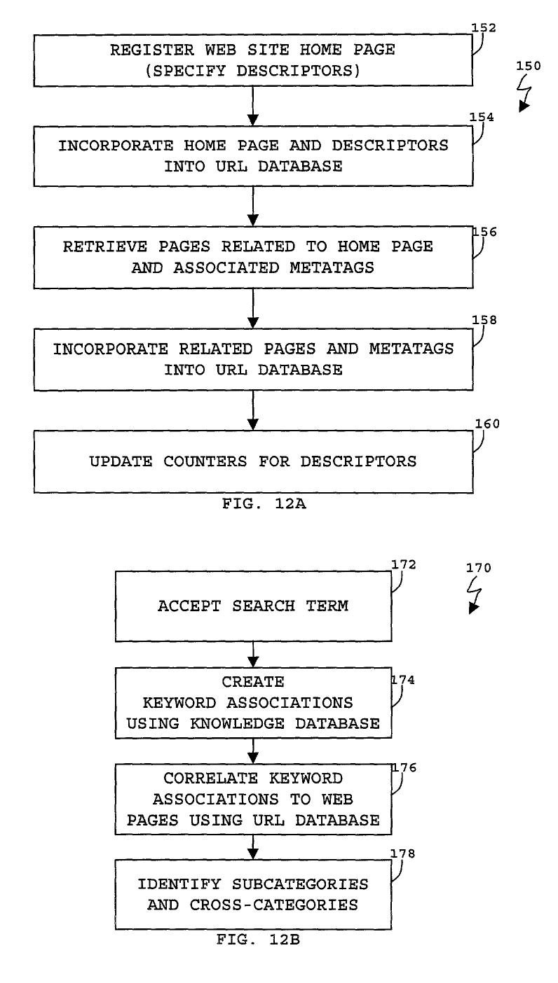

Referring now to FIG. 12A, there is shown an exemplary block diagram indicating a process 150 by which information from a registrant or user can register a website. In the FIG. 12A process 150, a registrant can visit a webpage 152 such as indicated herein for registering a URL, although those with ordinary skill in the art will recognize that the exchange of information between a registrant and the system is not required to be via a webpage, and URL registration can occur through other data exchange methods including mail-in registration forms, registration information received via telephonic methods, or any other well-known method for communicating data between parties. In accordance with the URL registration process, the registrant can specify descriptors, wherein the URL and the descriptors can be incorporated 154 into the URL Database, for example, in a system as shown in FIG. 8 104. The webpages associated with the registered URL can be retrieved using a bot 156 and the metadata for the associated pages can also be retrieved. The associated webpages and respective metadata can be incorporated 158 into the URL database and respective counters for descriptive words or terms can be updated accordingly 160. In the illustrated systems, counters are associated with the URL database descriptive terms to track the number of associations of a given descriptor to URLs. In the illustrated systems, this updating is performed as entries are added to the URL database, although other the counters can be updated at fixed intervals or other times without departing from the scope of the invention.

Referring now to FIG. 12B, there is an illustrative block diagram indicating a process 170 to be performed when a user or other visitor to the Web Organizer webpage enters a search term(s) in the keyword entry box 130 (FIG. 9) and selects the Search button 128. The illustrated systems, upon accepting the search term(s) 172, creates keyword associations with the search term 174 by extracting information from the Knowledge Database 102 of FIG. 8, otherwise known as the reciprocal two-stage memory. For the illustrated methods and systems, the keyword associations can be derived using any one or more of the previously detailed extraction methods, depending upon the number of search terms specified in the keyword box 130. For example, if only a single search keyword is presented in the keyword box 130, extraction algorithms such as reduction and deduction can be implemented to form keyword associations. Alternately, if multiple search terms are presented, keyword associations can be determined using extraction methods of recall, categorization, and reasoning. In some embodiments, a single extraction method can be used for single search word input while another extraction method can be used for multiple search word inputs. In other embodiments, for example, a single search word input can produce keyword associations according to reduction and deduction, while a multiple search word input can cause keyword associations according to recall, categorization, and reasoning. By utilizing the extraction methods provided herein, alone or in combination, the keyword associations provide a dynamic result (keyword associations) for the search word input(s).

In an embodiment, the Knowledge Database 102 can include only the descriptor terms defined or otherwise registered by URL registrants. In such an embodiment, the processes of reduction, deduction, recall, categorization, reasoning, etc., may not be used to provide search results.

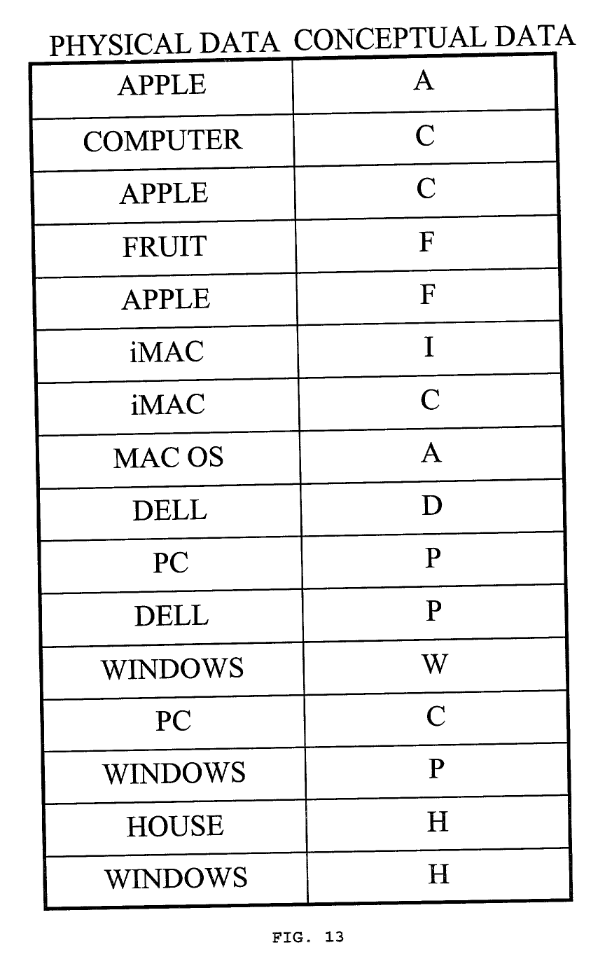

Referring now to FIG. 13, there is shown an exemplary portion of an illustrative Knowledge Database 102. For example, if the search term is “Apple” and the extraction methods of reduction and deduction are utilized, the keyword associations according to the memory of FIG. 13 include “Fruit”, “Computer”, and “MAC OS.” Alternately, if the search term is “Windows”, and deduction is the extraction method, the resulting keyword associations include “House”, and “PC”.

Returning now to FIG. 12B, once the keyword associations are identified 174, the URL Database 104 can be searched according to the search term(s) and the keyword associations 176 to determine subcategories and cross-categories of the search term. In an embodiment, the keyword associations from the Knowledge Database 102 can be understood to be additional search terms for searching the URL database 104. For example, if the search term is “ABC” and the keyword associations from the Knowledge Database 102 are “DEF” and “GHI”, the URL database search identifies URLs having descriptors of “ABC” or “DEF” or “GHI.” In an embodiment, the user whom enters the “ABC” term does not understand that the “DEF” and “GHI” terms are also being included as a logical “OR.” As indicated previously, by utilizing the Knowledge Database 102 to develop keyword associations, and providing a mechanism wherein registrants can add non-traditional associations to the database, searches are dynamic and more exhaustive when compared 11 to traditional searching techniques.

Returning to the example provided herein as related to FIG. 13 and the illustrated systems, wherein “Apple” is entered by a user as an “exact” search term, and the Knowledge Database 102 produces “Fruit”, “Computer”, and “Mac OS” as keyword associations, a search through the URL database 104 can be performed to identify URLs having a descriptor, metadata, etc. (herein referred to collectively as a “descriptor”) equal to any of “Apple” or “Fruit” or “Computer” or “Mac OS.” This set of identified URLs, together with the other descriptors related to the identified URLs, can form a basis for identifying what shall herein be referred to as subcategories and cross-categories.

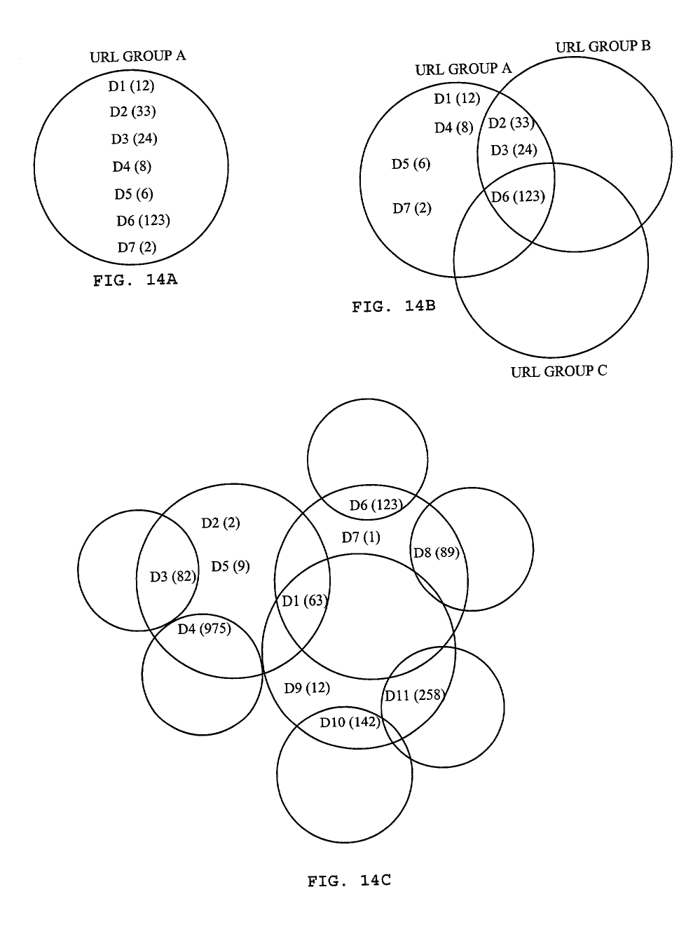

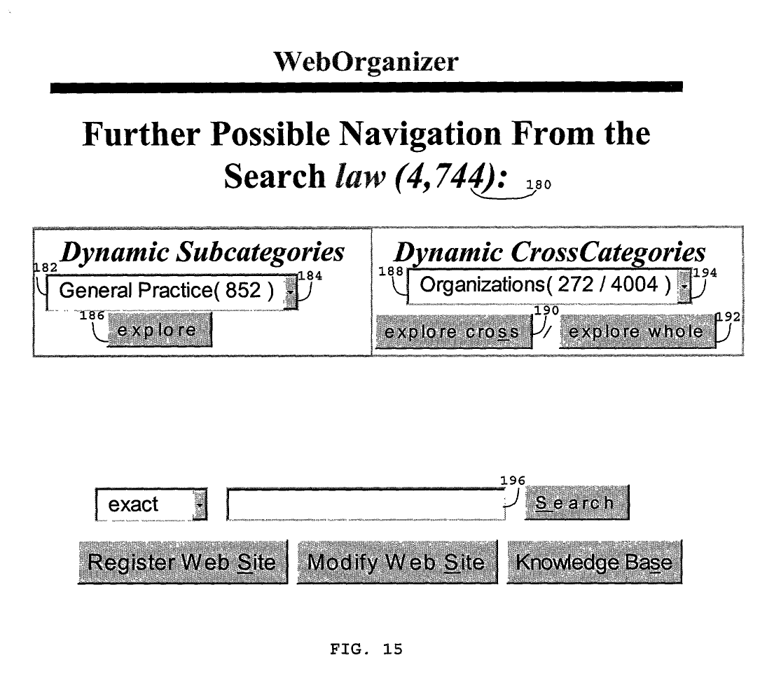

Subcategories of the identified search term can be understood as descriptors associated exclusively with an IP address to which the search term is also associated. Alternately, cross-categories are descriptors associated with an IP address to which the search the term is also associated, but such association is not exclusive to the URLs or IP addresses to which the search term is associated. Cross-categories can also be identified as keyword associations from the Knowledge Database 102 that can be associated with one or more URLs in the URL Database 104. Keyword associations from the Knowledge Database 102 that are not included in the URL database 104, in the illustrated systems and methods, are not further utilized. For example, consider a search term entered into a keyword entry box 130 such as shown by FIG. 9, wherein the keyword is entered by a user of the Web or Internet Organizer and represented as D1. As a first example, consider that the Knowledge Database 102 does not provide any keyword associations for D1 (alternately, it could be said that any keyword associations provided by the Knowledge Database 102 did not have any presence in the URL Database 104). The search term, D1, however, does have an association with URL GROUP A as shown in FIG. 14A, wherein URL GROUP A is further associated with descriptors of D2, D3, D4, D5, D6, and D7. Those with ordinary skill in the art will recognize that URL GROUP A is a group of related URLs that can be understood as a group of URLs having the same IP address. Similarly, the search term, D1, and/or descriptors D2-D7, can be a single or multiple-word term. The search term, D1, and descriptors D2-D7 associated with URL GROUP A can also be associated with a number of occurrences that the search term or descriptor occurs in the URL Database. Such numbers of occurrences are represented in parentheses beside the search term/descriptor as shown in FIG. 14A. For the purposes of illustration, it can be understood that the search term D1 and descriptors D4, D5, and D7 are only associated with URL GROUP A, while D2, D3, and D6 are associated with URL GROUP A and other URLs and/or URL groups. The respective associations can otherwise be viewed by FIG. 14B, wherein descriptors D2 and D3 are otherwise associated with URL GROUP B, and descriptor D6 is otherwise associated with URL GROUP B and URL GROUP C. Those with ordinary skill in the art will recognize that other descriptors for URL GROUP B and URL GROUP C can exist, but may not be shown in FIG. 14B. For the example as shown of FIG. 14B, descriptors D4, D5, and D7 are subcategories of search term D1 as such descriptors are associated with only URL GROUP A (i.e., IP address relating to URL GROUP A), while descriptors D2, D3, and D6 are cross-categories of search term D1 because D2, D3, and D6 are associated not only with URL GROUP A, but with another URL GROUP(s).

FIG. 14C provides a more complex example, wherein the search term, D1, is associated with more than one URL group. In such an example, URL GROUPs are once again represented by circles, with descriptors represented as D1-D11 and respective numbers of URL associations in parenthesis. For the example wherein search term D1 is associated with three URL groups, the descriptors for the three URL groups can be analyzed to determine whether those descriptors are subcategories or cross-categories of the respective URL group. From the example shown in FIG. 14C, D2, D5, D7, and D9 can be subcategories, having exclusive association with URL groups associated with the search term (D1). Alternately, D3, D4, D6, D8, D10, and D11 are cross-categories associated with URL groups that are similarly associated with the D1 search term, but such descriptors also have an association with other URL groups. The numbers of associations that the cross-category maintains with the search term URL and at least one other URL can be presented, while a separation presentation can be provided for the number of associations of the cross-category term with all URLs (i.e., not just the search term URL). In an embodiment, this latter association can be presented as the “whole” cross-category.

As indicated previously, keyword associations produced by the Knowledge Database 102 that have associations to URLs in the URL Database 104 can also be known as cross-categories in the illustrated systems and methods.

The illustrated systems and methods provide the results of the search to the user with respect to the number of URLs associated to the search term, the names of the subcategory descriptors and the respective number of associations of the subcategory term to the respective URL family, the names of the cross-category descriptors and the respective number of associations of the cross-category term to the search term URLs, and the number of associations between the cross-category descriptor and all URLs (i.e., “whole”). In an embodiment, users can be provided an opportunity to search a subcategory, a part of a cross-category having commonality with the original search term, or the whole cross-category. Those with ordinary skill in the art will recognize that the invention herein is not limited to the information displayed to the user, and that less or more information can be presented to the user in varying formats without departing from the scope of the invention.

In one embodiment, search results can be presented by providing URL links to the respective webpages or URLs, wherein the links can be HTTP links. In one embodiment, URL links can be presented twenty per page, with the user able to select “next” and “previous” selections accordingly to view the next twenty links and the previous twenty links, respectively. As indicated previously, users can additionally and optionally be provided with the names of all subcategories and cross-categories, and the users can select to explore a subcategory or cross-category, whereupon the search results can be presented in the same format of total hits, subcategories, cross-categories, etc.

Referring now to FIG. 15, there is an illustrative embodiment wherein search results can be presented for a search term of “law”. In the FIG. 15 representation, the search results indicate 4,744 URLs related to law 180, wherein these links can be individual pages of related URLs or URLs within a family of URLs (i.e., single IP address). Subcategories of the search term can be presented as Dynamic Subcategories 182, and in the illustrated embodiment, the subcategories are listed in order of the most URL associations, with a user able to view or scroll through the list of subcategories using an arrow key 184 that controls a drop-down object. In the illustrated system, the user can explore any dynamic subcategory 182 by selecting the subcategory 182 to display, and depressing the “explore” key 186 that causes a new search to be performed. Returning to FIG. 15 wherein the search results for a search term of “law” are provided, dynamic cross-categories 188 can be presented. For the illustrated search wherein “Organization” is an illustrated cross-category, it can be interpreted that 272 URLs have “law” and “organization” as descriptors, while 4004 URLs maintain “organization” as a descriptor. As with the subcategory option, users can further search either the portion of the cross-category overlapping with the search term or the entire cross-category by selecting the “explore cross” 190 or “explore whole” 192 selector options, respectively. Also, cross-categories can be selected using an arrow 194 to access the contents of a drop-down box object to display, scroll, and select a cross-category. Those with ordinary skill in the art will recognize that drop-down objects can be replaced with radio buttons, check-box objects, or other selectable options without departing from the scope of the invention.

In the FIG. 15 embodiment, a user also has the option of beginning a new search by entering the search term in a keyword box 196. Those with ordinary skill in the art will recognize that the information presented in FIG. 15 can be reformatted, expanded, and reduced without departing from the scope of the invention.

What has thus been described is a system and method to organize information on the internet for rapid and organized retrieval. Registrants of websites can register URLs by specifying the URL and associated descriptors. A bot automatically determines URLs and metadata associated with the registered URL. The URLs and descriptors and/or metadata form a URL database. Search terms entered by users can be indexed against a knowledge database using one or more retrieval algorithms to provide keyword associations. The knowledge database further includes a knowledge acquisition and retrieval system and method that include at least one first memory segment, and a distinct second memory segment, wherein elements of the at least one first memory segment reciprocally associate to elements of the second memory segment. Registrants can modify the knowledge database to incorporate non-traditional associations. The search term, keyword associations, and URL associations provide an organized search result that includes subcategories and cross-categories of information that can be further searched by the user. URL links can be provided in the search results.

Although the present invention has been described relative to a specific embodiment thereof, it is not so limited. obviously many modifications and variations of the present invention may become apparent in light of the above teachings. It will be understood that although the systems have been described with reference to functional blocks, the systems described herein can be computer programs, such as C language or Java language programs, and that the blocks depicted herein are merely representative of the procedures and functions that can be performed by the program. It will further be understood that the systems can be dedicated hardware devices, or combinations of hardware and software. For example, although the examples provided indicated three reciprocal database associations for each physical-conceptual input pairing, multiple-valued pointers may be implemented to effectuate the three relationships using fewer than three database entries. A database structure is not required, and the system may be built upon different memory segments. Additionally, the physical memory segment may comprise a single memory device with multiple partitions, or multiple memory devices, or combinations thereof. The conceptual memory segment may be similarly structured. Although the system provided for auditory, visual, language, motion, and sensor inputs and outputs, only one or a subset of such input/output devices may be utilized. Similarly, the input and output interfaces for the different input or output modes may be shared, separate, and may require multiple interfaces for a single input or output mode. Although the system was structure as having input, storage/association, retrieval, and output modules, the modules are not required to be structured as such, and functionality may be incorporated otherwise. The preferred embodiment presented seven different retrieval algorithms, but the invention may be practiced with fewer than seven retrieval algorithms. The web organizer graphical user interfaces are provided for illustration and not limitation, wherein any similarly designed interface for exchanging information between the user and methods and systems according to the invention herein can be utilized. Although the web organizer utilized objects such as drop-down boxes to present search results, other mechanisms could be utilized including radio buttons, check boxes, and other well-known input and/or display objects. Although the bot or robot for the illustrated systems and methods herein retrieved and incorporated metadata as descriptors for URLs associated with registered URLs, other embodiments of the invention can incorporate other products of associated URLs as descriptors, including but not limited to descriptors that are retrieved from databases associated with the URLs, keywords associated with the URLs, keywords as a product of text scans of the URLs, etc. The Knowledge Database and URL database, although represented herein as separate databases for illustrative purposes, can be understood to represent a single database having multiple partitions.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A system for searching information on a network, comprising
a Uniform Resource Locations (URL) database to associate URLs with at least one descriptor, and,
a knowledge database having at least one memory segment and a distinct second memory segment having elements reciprocally associated with elements of the at least one first memory segment, wherein the reciprocal associations further include,
a conceptual hierarchical relationship between elements of the at least one first memory segment by traversing the reciprocal associations; and,
a conceptual hierarchical relationship between elements of the distinct second memory segment by traversing the reciprocal associations.

2. A system according to claim 1, further comprising a graphical user interface to accept input from a user.

3. A system according to claim 2, wherein the GUI further includes a text box to accept at least one search term from the user.

4. A system according to claim 2, wherein the GUI further includes an option to search by exact search word or occurrence of search word.

5. A system according to claim 2, wherein the GUI further includes interface to register a URL.

6. A system according to claim 5, wherein the interface to register a URL further includes at least one of,
a text box to accept the URL for registration, and,
at least one text box to accept at least one descriptor of the URL.

7. A system according to claim 1, further including a robot to retrieve URLs and respective descriptors, the retrieved URLs being associated to a registered URL.

8. A system according to claim 7, wherein the respective descriptors include metadata.

9. A system according to claim 1, further comprising a graphical user interface (GUI) providing access to the knowledge database.

10. A system according to claim 9, wherein the GUI further comprises a text box for inputting a search term.

11. A system according to claim 9, wherein the GUI further includes at least one text box for displaying at least one of an element from the at least one first memory segment and an element from the second memory segment.

12. A system according to claim 9, wherein the GUI further includes at least one selectable option to input a data association to the knowledge database.

13. A system according to claim 1, further comprising a graphical user interface (GUI) to display search results.

14. A system according to claim 13, wherein the GUI further includes a display object for dynamic subcategories.

15. A system according to claim 14, wherein the display object further comprises a drop-down box.

16. A system according to claim 13, wherein the GUI further includes a display object for dynamic cross-categories.

17. A system according to claim 16, wherein the display object further comprises a drop-down box.

18. A system according to claim 13, wherein the GUI further includes at least one of an option to search a subcategory and an option to search a cross-category.

19. A system according to claim 13, wherein the GUI further comprises at least one reference to a URL.

20. A system according to claim 19; wherein the at least one reference includes a http link.

21. A method for associating at least one search term with at least one URL, comprising,
providing a URL database to associate URLs with at least one descriptor,
providing a knowledge database having at least one memory segment and a distinct second memory segment having elements reciprocally associated with elements of the at least one first memory segment, wherein the reciprocal associations further include,
a conceptual hierarchical relationship between elements of the at least one first memory segment by traversing the reciprocal associations; and,
a conceptual hierarchical relationship between elements of the distinct second memory segment by traversing the reciprocal associations, and,
providing URLs associated with the search term by accessing the URL database and the knowledge database based on the search term.

22. A method according to claim 21, wherein providing a URL database to associate URLs with at least one descriptor further includes providing a URL registration graphical user interface (GUI) for associating at least one URL with at least one URL descriptor.

23. A method according to claim 22, wherein the GUI further includes at least one text input object for accepting the at least one search term.

24. A method according to claim 21, further including providing a robot to retrieve URLs and respective descriptors for input to the URL database.

25. A method according to claim 21, further including at least one graphical user interface (GUI) to access the knowledge database.

26. A method according to claim 25, wherein the GUI further comprises a text box for inputting a search term.

27. A method according to claim 25, wherein the GUI further includes at least one text box for displaying at least one of an element from the at least one first memory segment and an element from the second memory segment.

28. A method according to claim 25, wherein the GUI further includes at least one selectable option to input a data association to the knowledge database.

29. A method according to claim 21, further comprising a graphical user interface (GUI) to display search results.

30. A method according to claim 29, wherein the GUI further includes a display object for dynamic subcategories.

31. A method according to claim 30, wherein the display object further comprises a drop-down box.

32. A method according to claim 21, further comprising providing at least one subcategory based on the at least one search term being associated with an Internet Protocol (IP) Address.

33. A method according to claim 21, further comprising providing at least one cross-category based on the at least one search term being associated with more than one Internet Protocol (IP) Address.

34. A method for providing URL information based on at least one search term, comprising at least one of
displaying at least one subcategory based on the at least one search term being associated with an Internet Protocol (IP) Address, and,
displaying at least one cross-category based on the at least one search term being associated with more than one Internet Protocol (IP) Address.

35. A method according to claim 34, further comprising displaying HTTP links to URLs associated with the at least one search term.

36. A method according to claim 34, wherein displaying at least one subcategory based on the at least one search term being associated with an Internet Protocol (IP) Address further comprises providing a URL database to associate URLs with URL descriptors.

37. A method according to claim 34, wherein displaying at least one cross-category based on the at least one search term being associated with more than one Internet Protocol (IP) Address further comprises,
providing a knowledge database having at least one memory segment and a distinct second memory segment having elements reciprocally associated with elements of the at least one first memory segment, wherein the reciprocal associations further include,
a conceptual hierarchical relationship between elements of the at least one first memory segment by traversing the reciprocal associations; and,
a conceptual hierarchical relationship between elements of the distinct second memory segment by traversing the reciprocal associations,
extracting associated keywords from the knowledge database, the associated keywords being reciprocally related to the at least one search term, and,
identifying associated keywords as cross-categories by correlating the associated keywords with at least one URL.

38. A method according to claim 34, further comprising providing at least one of,
a user option to search an identified subcategory, and,
a user option to search an identified cross-category.

39. A method for searching information on a network, comprising
providing a first database having associations of Uniform Resource Locations (URLs) and descriptors,
providing a second database to register descriptors with descriptor terms,
accepting a search query,
generating a search result that includes cross-categories, subcategories, and URL links, the search result based on the search query and the first and second database.

40. A method according to claim 39, further comprising providing an interface for registering a URL.

41. A method according to claim 39, further comprising providing an interface to inspect and modify the second database.

42. A method according to claim 39, wherein the second database further comprises,
at least one memory segment and a distinct second memory segment having elements reciprocally associated with elements of the at least one first memory segment, wherein the reciprocal associations further include,
a conceptual hierarchical relationship between elements of the at least one first memory segment by traversing the reciprocal associations; and,
a conceptual hierarchical relationship between elements of the distinct second memory segment by traversing the reciprocal associations.

42. A method according to claim 39, wherein generating a search result that includes cross-categories further includes,
determining additional descriptors associated with the same URLs as the search query is associated,
identifying the additional descriptors associated with additional URLs, wherein the additional URLs are not associated entirely with the search query, and,
providing the identified additional descriptors as cross-categories.

43. A method according to claim 39, wherein generating a search result that includes subcategories further includes,
determining additional descriptors associated with the same URLs as the search query is associated,
identifying the additional descriptors that are not associated with URLs other than URLs associated with the search query, and,
providing the identified additional descriptors as subcategories.
